(19) United States
(12) Patent Application Publication
(10) Pub. No.: US 2003/0089143 A1
(43) Pub. Date: May 15, 2003

(54) Device for locking golf clubs in a golf bag

(76) Inventor: Dan Sebastian Lindkjolen, Kongsberg (NO)

Correspondence Address: SIERRA PATENT GROUP, LTD., P O BOX 6149, STATELINE, NV, 89449, US

(21) Appl. No.: 10/227,624

(22) Filed: Aug. 22, 2002

(30) Foreign Application Priority Data
Nov. 9, 2001 (NO) 2001 5495

(51) Int. Cl. E05B 73/00

(52) U.S. Cl. 70/58

(57) ABSTRACT

A locking device for locking golf clubs in a golf bag and the like, comprising a continuous chain of hinged links, where the links are formed so that two adjacent links in a first mutual position enclose the golf club shaft so as to prevent the golf club from being taken out of engagement with the links, while the links in a second mutual position partly enclose the shaft of the golf club, allowing the golf club to be removed.

### PRIOR APPLICATIONS

This application claims priority to Norway application number; 2001 5495 filed on Nov. 9, 2001.

### BACKGROUND

The present invention regards a device for securing golf clubs, preferably in golf bags.

The theft of golf clubs from golf bags has become a serious problem. Both single clubs and entire bags and their contents get stolen, especially when the bags are left unattended outside the club house. As a result, recent years have seen the development of several devices that wholly or in part prevent the theft of golf clubs from golf bags, and also entire golf bags.

SE 462 582 describes a device for locking golf clubs in a golf bag, comprising a plate having slits matched to the golf club shafts. A bow closure is adapted for closing the open end of the slit, thereby preventing the removal of the golf clubs from the bag.

From U.S. Pat. No. 5,524,753 there is known a locking device comprising two plates on top of each other having elongated cutouts. The cutouts are wide enough for the shaft of the golf club to be put through the cutouts. The plates may then be displaced relative to each other and locked in a position in which the golf club can not be pulled out again.

Common to all these solutions is the fact that they are relatively complicated and involve a large number of mechanical components, they weight quite a lot, remain part of the golf bag, and have so far not been a success in the market due to said facts.

### SUMMARY

Thus an object of the present invention is to provide a locking device for golf clubs, whereby the problems associated with previous solutions are avoided. It is furthermore an object to solve the problem of theft of golf clubs in a manner that is satisfactory to the golf player, so that the locking device may easily be put on and removed from the clubs, that it is lightweight, and that it can be easily be removed from the actual golf bag with one simple grip.

This object is achieved in accordance with the present invention by a locking device for locking golf clubs in a golf bag or similar, comprising a continuous chain of hinged links, where the links are constructed so that two adjacent links in a first mutual position may enclose the shaft of a golf club in a manner so as to prevent it from being taken out of engagement with the links, while the links in a second mutual position partly enclose the shaft of the golf club, so as to allow the golf club to be removed.

Preferably, the chain of hinged links can form a closed ring when all the links are in the first mutual position relative to their adjacent links.

Preferably also, the chain may be locked together as a closed ring.

According to a preferred embodiment, at least one of the interconnected links is formed with a cutout that is open to the outside of the of the link in order to receive the shaft of the golf club, where the other link closes the opening of the cutout towards the outside when the links are in the first mutual position, and does not close the opening of the cutout towards the outside when the links are in the second mutual position.

It is preferable for the two interconnected links to be constructed with cutouts that are open to the outside of the link in order to receive the shaft of the golf club, the cutouts together forming a hole in which the shaft of the golf club can be accommodated when the links are in their first mutual position, and the cutouts in adjacent links overlapping to allow the golf club to be removed from the cutout when the links are in their second mutual position.

Preferably, two adjacent links are inter-rotatable about an axis substantially coincident with the longitudinal axis of the shaft of a golf club placed in the cutout.

It is preferable that grooves in the shape of a sector of a circle be provided on each link, where the centre of the sector in the main coincides with the axis, and where the sector shaped grooves engage projections on the adjacent link.

The present locking device is flexible both with regard to the furnishing of the bag and the number of golf clubs in the bag.

### BRIEF DESCRIPTION OF THE DRAWINGS

The present invention will be described below with reference to a preferred embodiment and the accompanying figures, in which:

FIG. 1 is a top view of a preferred embodiment of the present locking device;

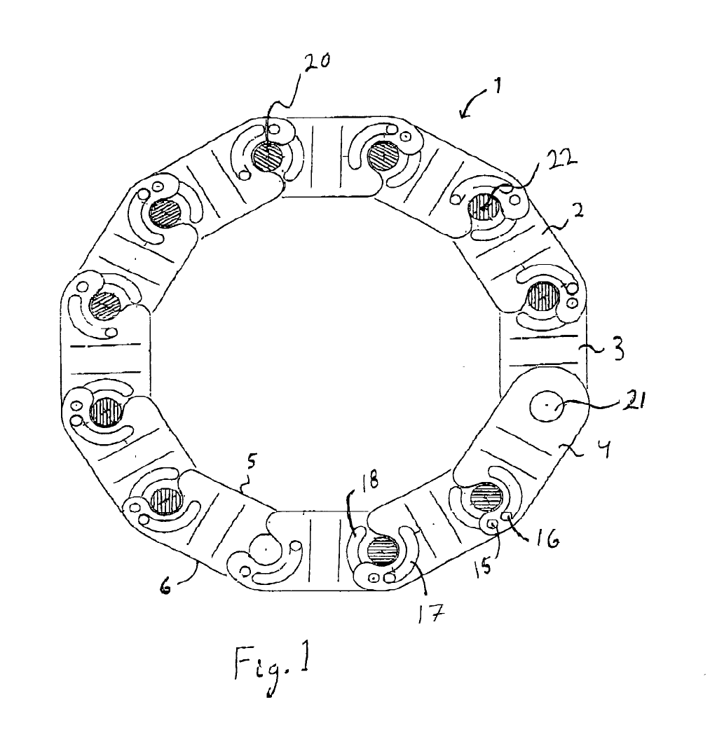

FIG. 2 is a side view of two links in the present locking device; and

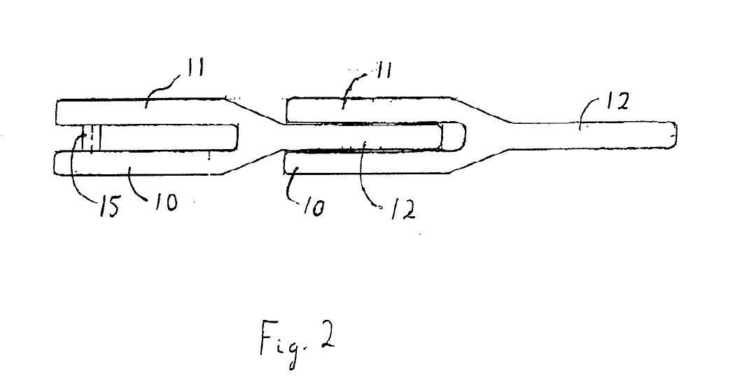

FIG. 3 is a top view of four links in the present locking device in the closed and open positions.

### DETAILED DESCRIPTION

As shown in the figures, the locking device consists of one chain 1 of links 2, 3, 4 that may be joined together to form a ring. Seen in the plane of the ring, the links 2, 3, 4 in the embodiment illustrated are essentially rectangular, with parallel long sides 5, 6. The ends 7, 8 are preferably rounded as in the enclosed figures.

The ends 7, 8 of the links define a cutout 9 adapted to match the thickness of the shaft of a golf club. Preferably, the innermost portion of the cutout 9 is semicircular, where the diameter of the semicircle is matched to the diameter of the shaft 20 of the golf club and with a wider opening out of the link.

Viewed at right angles to the plane of the ring, each link 2, 3, 4 is forked, so as to consist of two arms 10, 11 at one end and one arm 12 at the other end. The spacing between the arms 10, 11 is matched to the thickness of the arm 12, so as to allow the arm 12 to be inserted between the arms 10, 11 and the links to be rotated relative to each other in the plane of the ring.

In the preferred embodiment of the present locking device 1 shown, the links are joined in a manner such that the links rotate about an imaginary axis 22 that essentially coincides with the center of the semicircular portion of the cutout 9. Thus the axis 22 is also essentially coincident with the longitudinal axis of a golf club placed in the cutout 9. This is achieved by grooves in the shape of sectors of circles 17, 18 being formed in the links 2, 3, 4, the center of which grooves also essentially coincides with the imaginary axis 22. Projections 15, 16 are attached to respective links, and run in the grooves 17, 18 of the adjacent link. This way, the cutouts 9 on the adjacent links form an approximately circular hole that encloses a golf club when the links are in their one mutual position and a groove open to the outside for removal of golf clubs when the links are in their other mutual position.

The locking device for golf clubs according to the present invention is formed by a chain of identical links 2, with an end link 3, 4 at either end. At one end, the end links 3, 4 are connected to a link 2, and at the other end, they have a closed eyelet 21 for fastening a lock upon the two end pieces being brought together. The locking device can have any desired number of links, but will normally be restricted to 14, as this is the maximum number of golf clubs allowed at the same time.

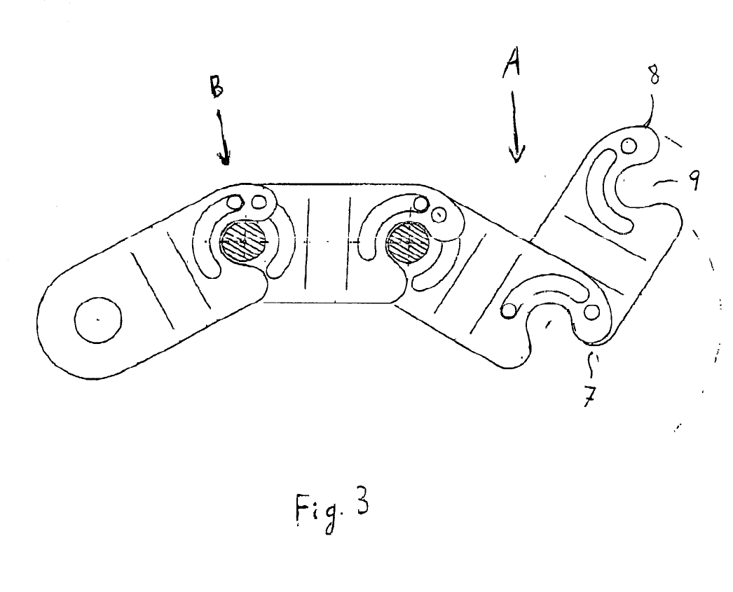

Golf clubs may be placed in the grooves between two links when these are in the “open” position marked “A” in FIG. 3, by the thinnest point of the golf club, the shaft immediately below the head of the club when positioned upside down in the bag, is being guided into the cutout 9. The links are then rotated relative to each other to a position marked “B” in FIG. 3. When all the clubs to be locked in have been placed in the device in this manner, a lock such as a pad lock may be inserted through the eyelet 21 of both end links 3, 4 to make the locking device form a closed circle.

The lock used to lock up the locking device may be a pad lock. The lock may optionally be attached to the bag by means of e.g. a wire, chain or similar, so as to lock the locking device to the bag. A wire, chain and the like may also be used to lock the bag and the locking device to a fixture for locking of golf bags.

The preferred embodiment of the present locking device described allows opening and closing of the cutout by the links 2, 3, 4 being rotated relative to each other. This can also be achieved by use of other hinged mechanisms that are also covered by the enclosed claims. A hinged mechanism that rotates about a physical axle will however cause the diameter of the hole in which the shaft of the golf club is placed to change with the rotation of the links. This is detrimental, as the shaft of the golf club is made from relatively thin-walled tubes that may easily be damaged by pressure. It is clear however, that this problem may be overcome by using stops that prevent the links from rotating through more than a predetermined angle. By use of the present hinged mechanism, the diameter of the hole enclosing the shaft of the golf club is not changed. The hole formed by the cutouts 9 may therefore have a diameter closely matched to the diameter of the shaft, allowing the clubs to be held without being squeezed. Furthermore, the cutout 9 may be lined with materials that provide further retention of the shafts, which may be desirable in order to prevent the clubs from bumping into each other.

The hinged mechanism that enables the links to be rotated relative to each other without squeezing the shafts of the golf clubs may be realised in other ways than described herein. As an example, the grooves 17, 18 need not be through-going. They may be formed e.g. through pressing, casting or milling that surface which faces the adjacent link. Correspondingly, the projections 15, 16 may be projections that simply project from the material, not inserted projections.

The present locking device may be made from various materials. The purpose of the device is to reduce and possibly prevent theft of clubs and maybe entire golf bags. Even though the lock may not be solid enough to prevent the theft, it may prevent the thief from leaving with the goods unnoticed. This may be sufficient to reduce the problem of theft considerably. Thus the lock may be made from plastic materials, although metals, preferably light alloys, are preferable. However the choice of material is not limiting to the invention.

What is claimed is:

1. A locking device for locking golf clubs in a golf bag and the like, comprising a continuous chain of hinged links, wherein the links are formed so that two adjacent links in a first mutual position enclose a golf club shaft configured to prevent said golf club from being taken out of engagement with the links, wherein the links in a second mutual position partly enclose the golf club shaft, allowing the golf club to be removed.

2. The locking device according to claim 1, wherein the chain of hinged links form a closed ring when all the links are in the first mutual position in relation to adjacent links.

3. The locking device according to claim 2, wherein the chain is configured to lock in a closed ring.

4. The locking device according to claim 1, wherein at least one of the interconnected links is formed with a cutout that is open to the outside of the link in order to receive the golf club shaft, wherein another link closes the opening of the cutout to the outside of the link when both of the links are in said first mutual position and does not close the opening of the cutout to the outside of the link when the links are in said second mutual position.

5. The locking device according to claim 4, wherein both interconnected links are formed with cutouts that are open to the outside of the link in order to receive the golf club shaft, wherein the cutouts together form a hole in which the golf club shaft can be accommodated when the links are in the first mutual position, and where the cutouts in adjacent links overlap to allow the golf club shaft to be removed from the cutout when the links are in the second mutual position.

6. The locking device according to claim 1, wherein two adjacent links are rotatable relative to each other about an axis that substantially coincides with the longitudinal axis of the golf club shaft placed in the cutout.

7. The locking device according to claim 6, wherein grooves formed as sectors of a circle are provided on each link, the center of the sector of a circle being substantially coincident with the axis, and the sector shaped grooves engaging projections on the adjacent link.
